(19) United States
(12) Patent Application Publication
(10) Pub. No.: US 2008/0226434 A1
(43) Pub. Date: Sep. 18, 2008

(54) Hopper Container

(76) Inventors: Gordon O. Smith, Winnipeg (CA); Robert Calvin Hooper, Springfield (CA); Dennis M. Wray, Winnipeg (CA); Bryon Debaets, Windsor (CA)

Correspondence Address: ADE & COMPANY INC., 2157 Henderson Highway, WINNIPEG, MB, R2G1P9, CA

(21) Appl. No.: 10/598,276

(22) PCT Filed: Feb. 23, 2005
(86) PCT No.: PCT/CA2005/000257

§ 371 Date: Aug. 23, 2006

Related U.S. Application Data
(60) Provisional application No. 60/546,208, filed on Feb. 23, 2004.

(51) Int. Cl. B65G 1/20; B65D 88/28

(52) U.S. Cl. 414/332

(57) ABSTRACT

An intermodal hopper container comprises a structural frame defining a rectangular volume suitable for stacking with conventional intermodal containers. The structural frame of the hopper container forms plural compartments therein. Each compartment has a hopper formed at a bottom end which tapers downwardly and inwardly to a gate member. A hatch opening at a top end of each compartment is selectively covered by a hatch cover. The compartment walls are formed of rigid structural materials fixed to and which form part of the structural frame.

### FIELD OF THE INVENTION

The present invention relates to a container having a hopper discharge and which is suitable for stacking with intermodal containers on railcars or on trucks and the like.

### BACKGROUND

Shipping of particulate material including grain and the like is commonly accomplished by supporting the material in hopper rail cars or hopper trucks. When shipping overseas, the material must be unloaded from the hopper rail cars or trucks, typically for storage in a large common area in a ship. The material must then be again unloaded from the ship and into individual hopper rail cars or trucks upon reaching the overseas destination. Considerable material is lost due to spoilage or spilling while transferring the material from one container to another or while storing the material in a manner in which it is not protected suitably from the elements. Considerable time is also lost for repetitive steps of loading and unloading from hopper rail cars to hopper trucks or to the cargo hull of a ship.

Furthermore, in Canada for example, a number of smaller rural elevators have been closed in recent years with the development of new elevators with more capacity. This has lead to the closure of several branch lines of the railways, and has burdened the farmers/producers to truck their products longer distances into the system. The present system calls for grain at a base price and when it is marketed for delivery can take from one to six months into the future. Grains that are shipped via bulk spend as much as ninety days in the system and can be sold primarily in bulk ranging from 20,000 to 200,000 metric tonne lots. Rail freight and handling costs are the producer's single largest burden in transportation and the system presently requires multiple handling from farmer to final destination. With the multiple handling of the product, there are losses that occur at: elevators (loading and unloading); railcar movements (traveling); port terminals (loading and unloading); bulk ships (loading and unloading); destination ports (loading and unloading); and customers terminals/processors facilities (unloading). Product losses as spoilage, grade deterioration, traverse contamination and spillage, are estimated at about 2 to 3 percent of total volume shipped.

Physically maintaining segregation introduces operational inefficiencies throughout the system. It is estimated this can contribute as much as 7% of the handling cost at the terminals. The new wave of identity preservation in the bulk system causes congestion at the ports, which in turn holds up the reallocation of the rail hopper cars. It was estimated that 3 to 5 percent of grain exported from Canada is shipped via containers through established trade routes primarily with Asia and Europe through Vancouver and Montreal. This would represent approximately 750,000 metric tonnes annually by common dry box containers of TEU (20 foot) and FEU (40 foot). The trend in the United States is following with 9% of all US Agricultural in 1992 having been in containers. This amount was increased to 13% by 1998 and again it increased to 15% in 2002. This resulted in 125,000 containers used for animal feed and 37,000 used for soybean in 2002.

The producers do not know the dimension and design of the container inside until it arrives on site in most cases. The intermodal container industry has seen large increases over the last years in the amounts of containers being built and used. There seems to be no slowing down in the future mainly because of the demand for larger container ships of capacities of 9,000 to 9,500 TEU containers. These ships are currently being built and will be leaving the dry docks in the near future. There is also the lack of demand for the building of bulk ships in the last several years, because of the strong demand for more products to be moved by controlled containerization movements. These containers are loaded at the port with the use of Lining bags/stuffed, bagged products/palletized and stuffed without protection. Each of these methods has to be secured into placed and checked at different locations on route by inspectors for product shifting. This process is labor intensive and time consuming and is usually initiated at the port terminals but has been occasionally done inland. Alternatively, when there are no tip chassis trucks, the dry containers are loaded inland by the steps of: installing a bag; lifting one end and blocking; filling with grain; sealing the bag; installing a bulkhead; closing, locking and sealing the container doors; lowering the container; and loading onto a truck to be ready for shipment. With each lift of the containers, there is the need for a large lift-truck for 20-foot units or a minimum of a 45-ton crane for the 40-foot units when loaded. The costs of these units for every time needed could become expensive over a period. This method has experienced some drawbacks because of safety elements in the unloading procedure for workers at the customer's end. Another drawback is the limited amount of tips chassis trucks available at the customers end for unloading the containers.

U.S. Pat. Nos. 5,960,974 (Kee et al) and 5,529,222 (Toth et al) disclose examples of intermodal bulk containers including hopper discharge chutes at a bottom end thereof to assist in handling bulk materials. In each instance however, the compartments which actually hold the bulk materials are a separate structure from the surrounding frame of the container. Accordingly, there is considerable wasted space within the volume defined by the outer rectangular frame which is not used for storage of bulk material. Furthermore, additional mass is required to provide adequate structural support to the bulk compartments and the surrounding frame separately.

### SUMMARY

According to one aspect of the present invention there is provided a container comprising a structural frame defining a rectangular volume suitable for stacking with conventional intermodal containers and forming at least one compartment therein, said at least one compartment comprising:

a hopper formed at a bottom end of said at least one compartment which tapers downwardly and inwardly to a chute opening;

a gate member which selectively closes the chute opening of said at least one compartment; and

a hatch opening at a top end of said at least one compartment which is selectively covered by a hatch cover.

The use of a container including a structural frame forming the hopper compartments therein permits a hopper-type container for storing particulate material therein to be readily transported from railcars to trucks or into the cargo hull of ship by moving the container itself with the product therein with greatest efficiency. Integrating the hopper compartments structurally into the frame of the container maximizes interior volume while minimizing weight of the container as there is no redundancy is supporting structure when the compartment walls are themselves part of the structural frame. Accordingly there is no longer a need to empty the particulate material from conventional hopper rail cars and subsequently transfer the material to trucks or cargo ships previously resulting in frequent spillage and lost product from spoilage. Furthermore by maintaining the material within a single container during transport, the container can be readily sealed to prevent spoilage due to access to the product by moisture and the like resulting in contamination.

Accordingly, the compartments are preferably formed of rigid structural materials fixed to the structural frame in which side walls of the compartments comprise load bearing members of the structural frame. The side walls may be substantially planar and flush with exterior sides of the structural frame to maximize interior storage volume.

The structural frame preferably comprises upright corner posts at each corner of the frame, top and bottom rails spanning between respective top and bottom ends of the corner posts on each side of the frame, corner connectors at respective corners of the frame for coupling to adjacent intermodal containers and structural sheeted material spanning between the corner posts on each side of the frame which define side walls of said at least one compartment.

The structural frame may further comprise upright intermediate posts equally spaced between the corner posts in which the structural sheeted material spans an exterior of the intermediate posts.

The structural frame may further comprise partition members spanning across an interior of the structural frame between opposing sides of the structural frame for separating the compartments from one another. Preferably, the partition members are also formed of structural sheeted material.

The gate members preferably include an operating linkage for opening and closing the gate member wherein the gate member and operating linkage are selectively mounted on the hopper for ready replacement thereof using threaded fasteners.

Preferably the hatch covers also include an operating linkage for opening and closing the hatch cover wherein the hatch cover and operating linkage are selectively mounted on the compartment for ready replacement thereof using threaded fasteners.

Preferably the hatch cover and the gate member each include an operating linkage for opening and closing the respective hatch cover or gate member while the container is in a stacked configuration with an adjacent container of similar configuration. Preferably the operating linkages are accessible by an operator at either one of two opposing long sides of the structural frame.

The gate member is preferably fully contained within an area bound by the frame as the gate member is displaced between open and closed positions thereof. Likewise, the hatch cover is preferably fully contained within an area bound by the frame as the hatch cover is displaced between open and closed positions thereof.

The gate member and the hatch cover preferably both include a sealing member such that the compartments each form an airtight enclosure when both the gate member and the hatch cover are closed which is sealed with respect to adjacent compartments.

When the container is supported on a container carrying rail car having a deck upon which the frame of the container is supported, the hoppers of the container are supported above the deck of the rail car.

### BRIEF DESCRIPTION OF THE DRAWINGS

In the accompanying drawings, which illustrate an exemplary embodiment of the present invention:

FIG. 1 is a perspective view of a first embodiment of the hopper container.

FIGS. 2 and 3 are respective side elevational and top plan views of the hopper container.

FIGS. 4 and 5 are respective bottom plan and end elevational views of the hopper container.

FIG. 6 is a sectional view along the line 6-6 of FIG. 2.

FIG. 7 is a sectional view along the line 7-7 of FIG. 2.

FIG. 8 is a sectional view along the line 8-8 of FIG. 3.

FIG. 9 is a bottom plan view of one of the gate members in a partly opened position.

FIG. 10 is a sectional view along line 10-10 of FIG. 9.

FIG. 11 is a top plan view of one of the hatch covers in a closed position.

FIGS. 12 and 13 are sectional views along 12-12 of FIG. 11 showing the hatch cover in closed and open positions respectively.

FIG. 14 is a perspective view of a second embodiment of the hopper container.

FIG. 15 is a side elevational view of the container according to FIG. 14.

### DETAILED DESCRIPTION

Referring to the accompanying drawings, there is illustrated a hopper container generally indicated by reference numeral 10. The container 10 is particularly suited for the shipping and transport industry for being handled similarly to conventional intermodal containers which are stackable and which can be supported on container carrier railcars and trucks.

The hopper container 10 has a structural rectangular frame 12 which fully surrounds the container so that the container is suitable for supporting in a stacking configuration or on a generally horizontal supporting surface. The frame includes two bottom rails 14 which are parallel and spaced apart along opposing sides of the container along the bottom thereof.

Two top rails 16 are similarly parallel and spaced apart from one another along opposing sides of the top side of the container. Corner posts 18 join the top and bottom rails at each of the corners of the frame. A plurality of side posts 20 span between the top and bottom-rails, parallel to the corner posts at spaced positions along respective sides of the container. The rails and posts forming the structure of the frame 12 each comprise an angle formed of two perpendicular flanges to provide suitable strength to the frame.

Corner connectors 22 are provided at each of the corners frame 12 to permit the containers to be interlocked with one another when stacking similarly to conventional box-type intermodal containers. The frame further includes cross bars 23 which extend between the bottom rails 14 at spaced positions therealong and at respective ends thereof and similarly span the top rails 16 at spaced positions therealong and at respective end thereof. The cross bars 23 are similarly formed of an angle comprising two perpendicular flanges and are similarly interconnected between the corner connectors 22.

A center divider wall 24 is centrally located between the end walls of the container parallel thereto so as to fully span between opposing sides and between the top and bottom of the container. Partition walls 26 are also provided which are parallel to the center divider wall 24 spaced between the center divider wall and the ends of the container. Each of the walls 24 and 26 separates the hopper container 10 into a plurality of individual compartments 28. The number of divider walls and compartments formed depends upon the length of the container.

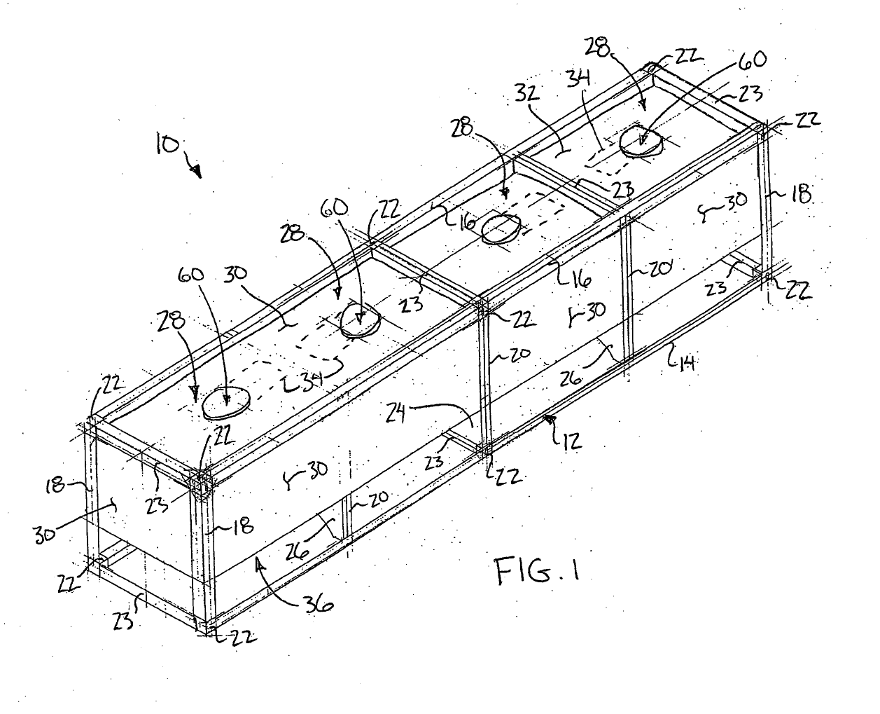

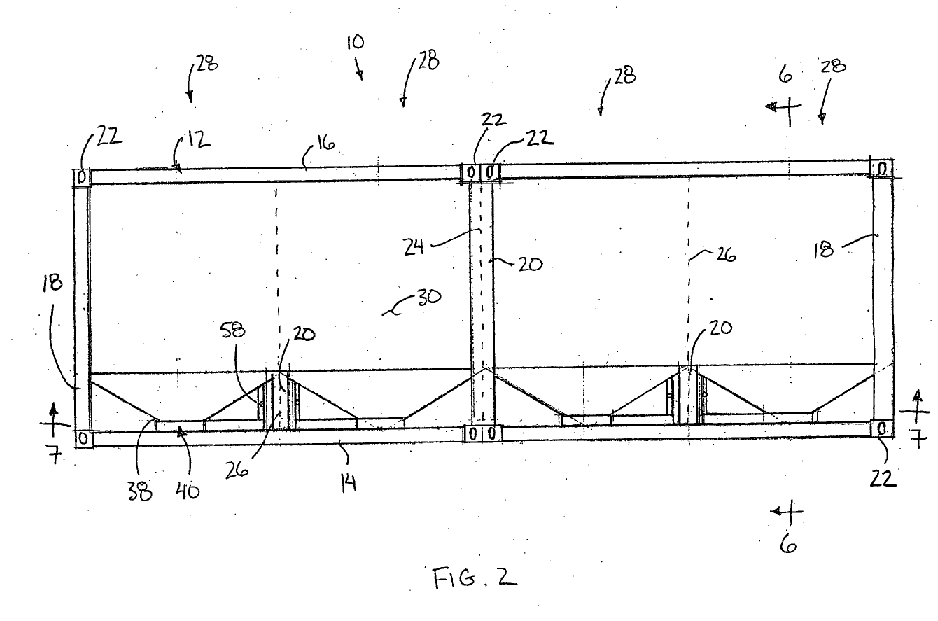

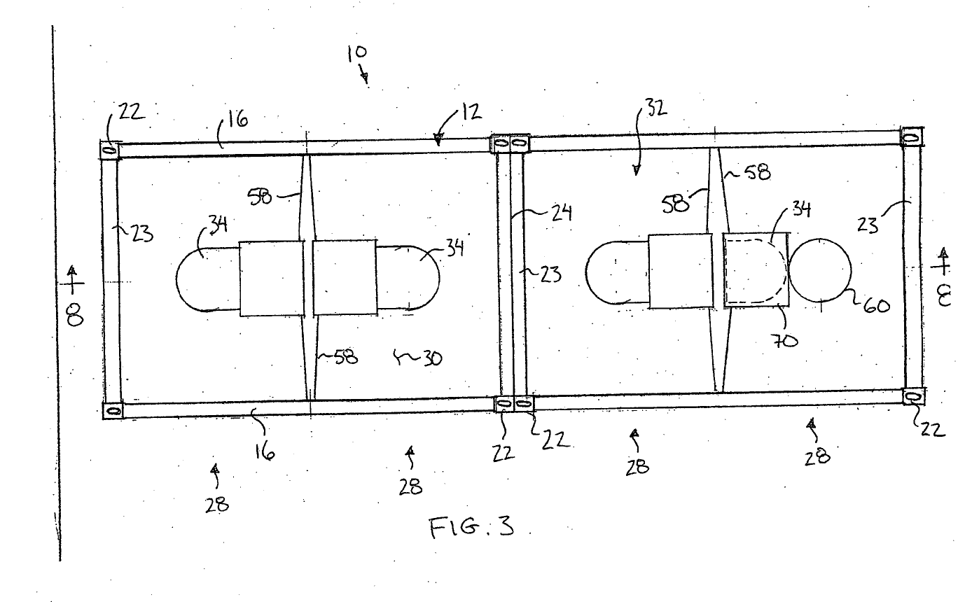

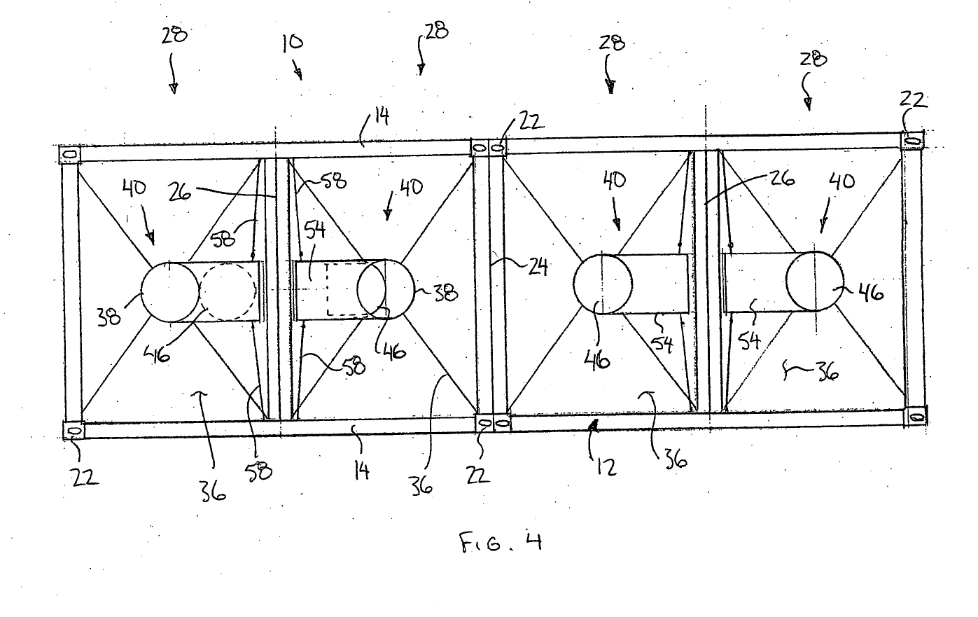

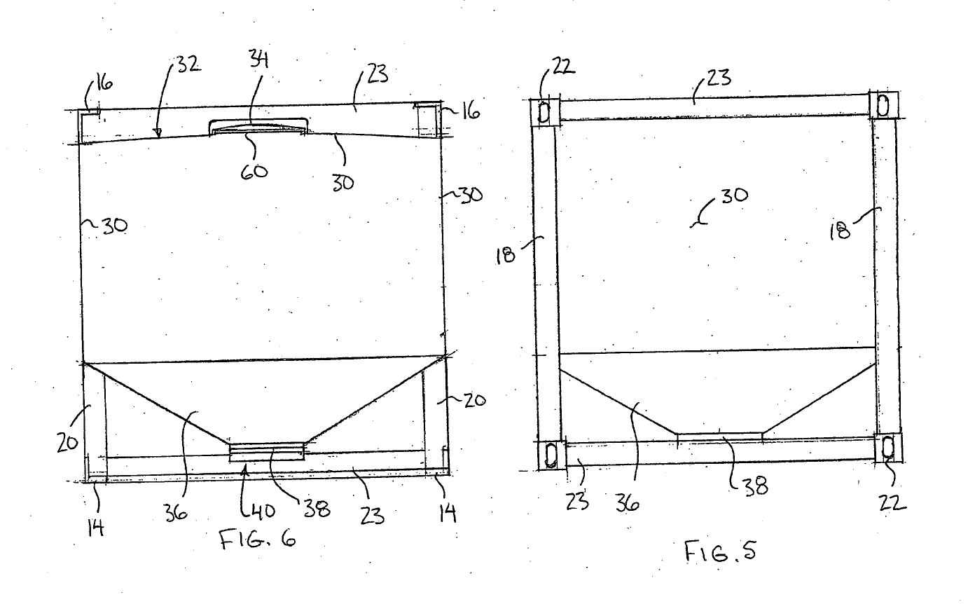

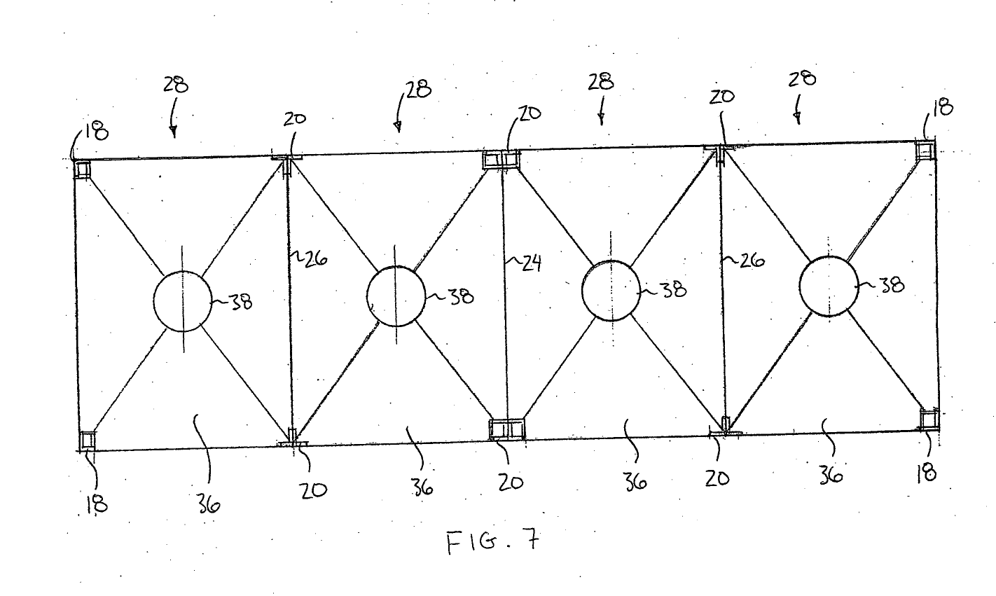

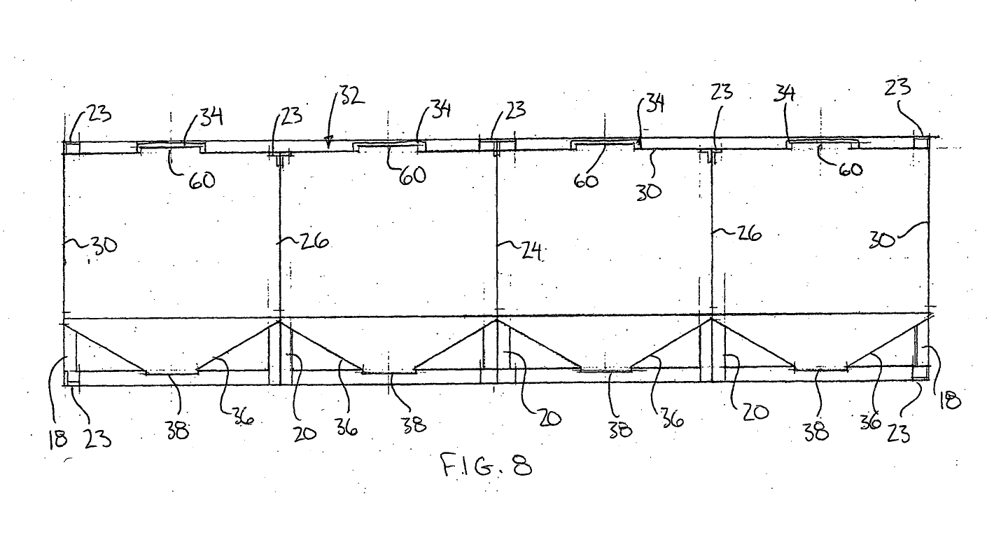

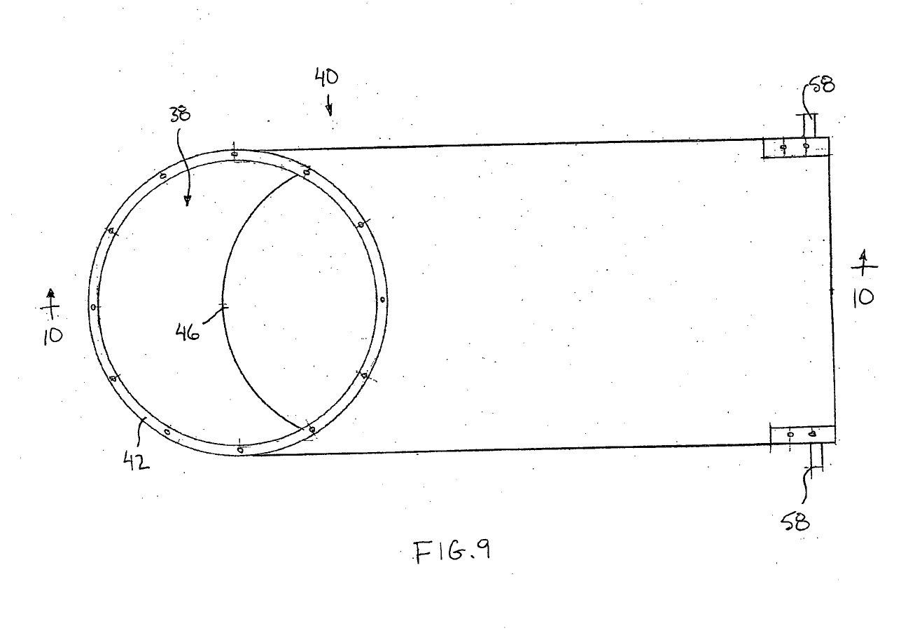

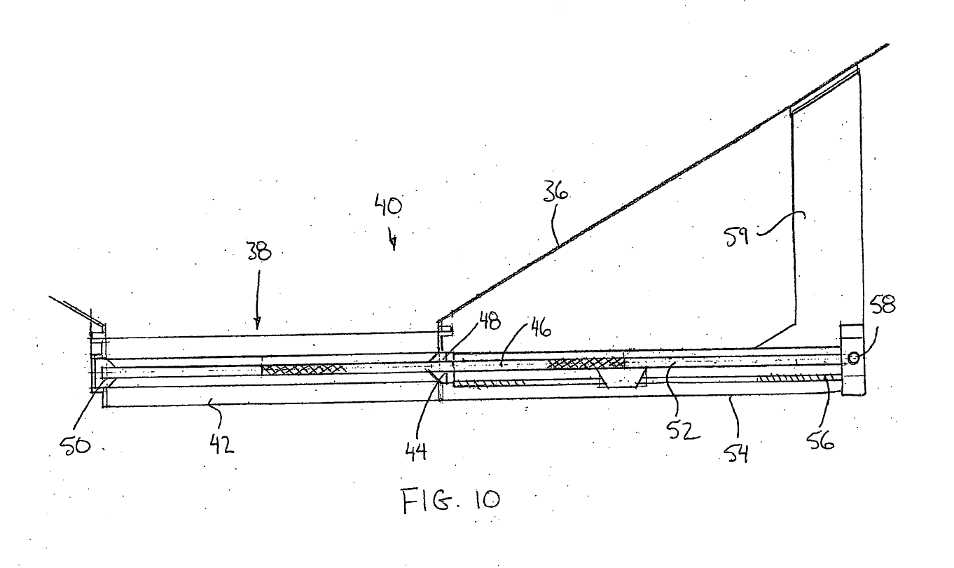

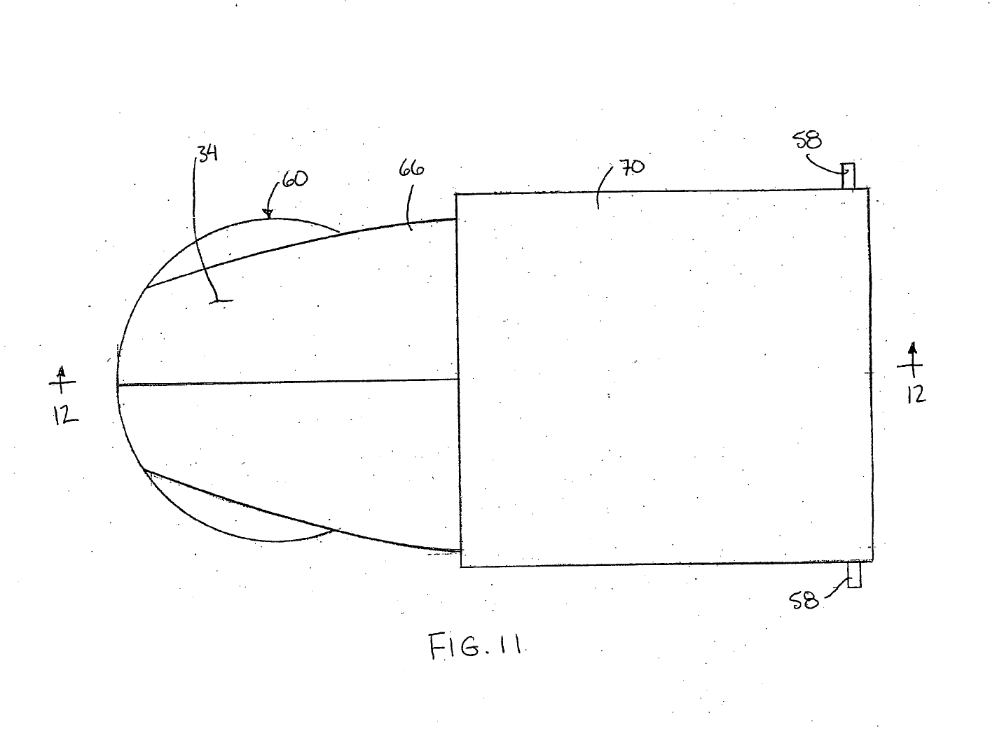

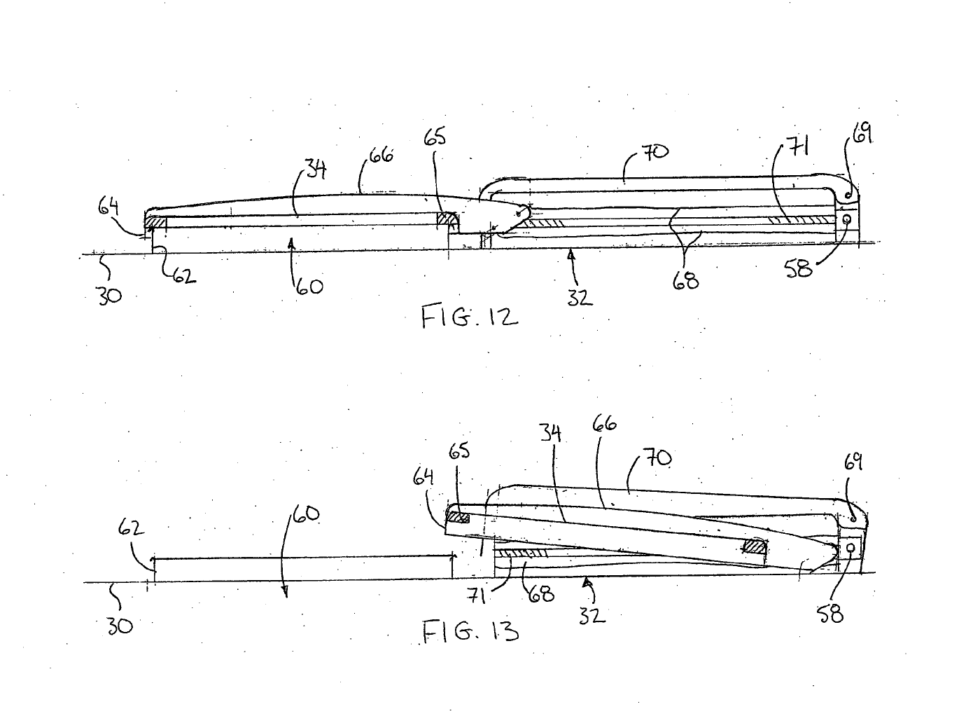

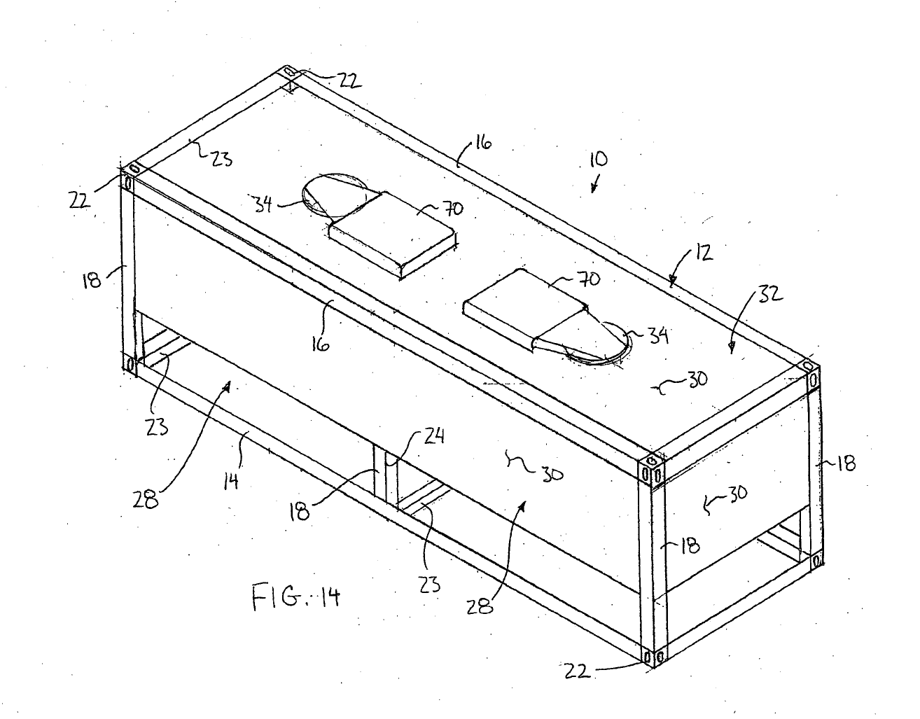

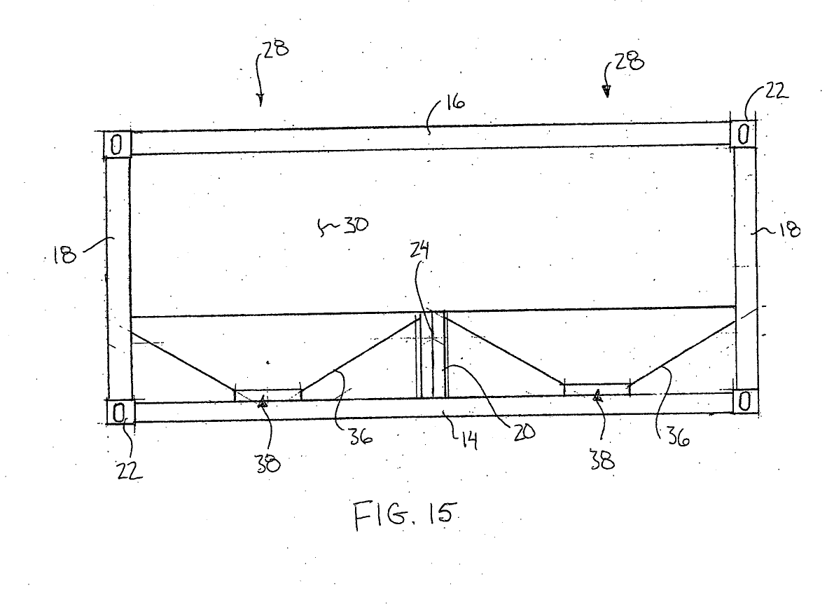

A twenty foot container, as shown in FIG. 14, is typically divided into two equal compartments whereas a forty foot long container, as shown in FIG. 1, is typically divided into four equal compartments. Accordingly partition walls 26 may not be required in a twenty foot long container as only a central divider wall 24 is sufficient.

Sheeted material 30 in the form of sheet metal spans the top, sides and end walls of the frame to enclose the compartments 28 formed by the walls 24 and 26. The sheeted material 30 may be formed in full sections which span a full length of the container or which span only the length of respective compartments 28. The top sheet 32 is located spaced below a height of the top rails 16 to provide sufficient space and clearance for hatch covers 34 associated with each of the compartments 28. A bottom side of each compartment 28 is enclosed by a hopper 36 having walls which converge downwardly and inwardly to a chute opening 38. A suitable gate 40 is mounted across the chute opening 38 for selectively closing the chute opening. The bottom of the hopper and the gate 40 supported thereon of each compartment 28 is spaced above a bottom side of the rails 14 at the bottom of the frame to provide clearance for the gates to open and close even when the containers are stacked a top one another or on top of the ground.

The sheeted material forming side walls of the compartments, as well as the partition members including the center divider wall, each comprise a structural member integrated with the frame and are load bearing when the container is stacked or has material stored therein. The sheeted material forming the side walls is generally planar and flush with the exterior sides of the container, extending across an exterior of the intermediate side posts 20 to maximize interior volume of the compartments bound by the side walls. The structural partition members spans the intermediate side posts at opposing sides of the container to provide structural support in addition to dividing the compartments.

The components of the frame 12 and sheeted material 30 spanning the frame members to form the compartments 28 are all formed of aluminium or other durable metal, for example steel or various lightweight alloys, and are of suitable dimension to form resulting hopper containers 10 which correspond in size to the conventional box-type containers. A forty foot long hopper container would typically be eight feet in width with a height ranging between 8 feet and 9.5 feet, while being divided into either three or four compartments resulting in a typical weight of approximately 119,000 lbs when loaded with product. Alternatively a twenty foot long container also having a width of eight feet and a height of 8 to 9.5 feet would typically weight approximately 59,500 lbs. when loaded with product.

Each gate 40 includes a collar 42 which defines the chute opening 38 therein which is approximately twenty-two inches in diameter. A slot 44 extends circumferentially half way around the collar 42 for slidably receiving a gate panel 46 therethrough. The top and bottom edges of the slot 44 in abutment with the gate panel include a suitable sealing member 48 formed therealong which seals against the gate panel in sliding engagement therewith. Diametrically opposite the slot 44, a compressible seal 50 similarly extends circumferentially around the collar 42 in alignment with the slot 44 for abutment with a rounded free end of the gate panel 46 when the gate is closed.

Opening of the gate is accomplished by slidably removing the gate panel 46 from the chute opening 38 by slidably receiving the gate panel through the slot 44. When open, the chute opening 38 is fully cleared of the gate panel so as to be unobstructed. The gate panel 46 is supported in a track 52 which slidably guides the gate panel therealong between the open and closed positions. A surrounding enclosure 54 receives the track 52 and the gate panel in the open position of the gate. A suitable actuator 56 in the form of a worm gear is provided for controlling opening and closing of the gate by a suitable crank connection 58 accessible from either long side of the frame of the container by a suitable driving rotary tool. The collar 42, gate panel 46 and all associated linkage components for opening and closing the gate are formed as an integral unit which is secured to the bottom of the hopper 36 by threaded fasteners to permit ready removal and replacement thereof as required for repair. A bracket arm 59 connects between the enclosure 54 and the bottom 36 of the hopper, spaced from the opening 38, to support the free end of the enclosure on the hopper bottom.

The components of the gate are made from any durable lightweight materials, for example aluminium, plastic or various lightweight metal alloys and the like. The configuration of the gate panel permits opening and closing of the gate in a sliding configuration which is low in profile to permit the gate to be fully contained above the bottom side of the frame while opening and closing so that opening and closing is permitted while the hopper containers are in a stacked configuration. The enclosure ensures that all mechanisms of the unit are protected from the elements. The gate will typically clear the bottom of the container by three to four inches with the mechanism only being three to five inches in total height so as not to interfere with other containers when stacked. Stops are preferably provided to control opening and closing of the gates for protection of the mechanism. The materials forming the components of the gate are sufficiently durable to resist the elements and resist breaking even during extreme weather conditions.

The hatch covers 34 are each associated with a respective one of the compartments 28 and are positioned so as to be in vertical alignment with the respective gate 40 associated with that compartment 28. The hatch covers 34 enclose a hatch opening 60 formed in the top sheet 32 of the container. The hatch openings similarly include a collar 62, bolted onto the top sheet and defining the opening by the interior diameter of the collar. The hatch openings preferably have a diameter which is greater than the gate openings so as to be approximately 24 inches in diameter. The covers 34 are circular in plan view with a depending peripheral flange 64 having a suitable sealing member 65 formed at an interior thereof for overlapping the exterior of the collar 62.

A support arm 66 mounts the cover on a free end thereof and rides within a respective track 68 for sliding displacement of the cover between the open and closed positions similarly to the gate. The support arm 66 guides the cover along the track to first raise the cover from the collar 62 initially in the closed position and subsequently slidably displace the cover in a radial direction in relation to the collar 62. Sliding movement continues along the track 68 until the hatch opening 60 is fully opened and clear of obstruction from the cover 34.

An enclosure 70 receives the cover 34, the support arm 66 and houses the track 68 therein to protect these components from the elements. The enclosure comprises a cover with a hinge 69 opposite the opening 60 to open and close as the cover 34 is selectively received therein. A worm gear 71 and suitable crank mechanism 58, which is accessible from both long sides of the frame of the container, is similarly provided for controlling sliding movement of the cover 34 relative to the track 68 between open and closed positions. The components of the hatch covers are sufficiently low in profile to be supported below the top side of the frame 12 of the container while opening to permit opening and closing of the hatch covers while the containers are stacked. The collar 62, the linkage components associated with the track and the enclosure 70 are all formed as an integral unit which is bolted onto the top wall of the container with threaded fasteners to permit ready removal and replacement thereof if required for repair.

The hatch covers are similarly made from any durable lightweight materials including aluminium, plastics, various metal alloys and the like. The track permits opening and closing of the hatch covers in a low profile sliding manner. All of the working components including the track and support arm are enclosed within the enclosure 70 to be protected from the elements. The collar 62 defining the rim of the hatch openings 60 is located approximately two inches above the top sheet of the compartments 28. The highest part of the mechanism controlling opening and closing of the hatch covers is within 5 or 5½ inches from the top of the sheet 32 forming the top of the compartments so that the mechanism for opening and closing the hatch covers is approximately an 1½ inches below the top side of the frame 12. In this manner other containers can be loaded on top of the hopper container without hitting the hatch covers. The bolt-on design of the hatch covers readily permits replacement thereof in the event that either the components are broken or inoperable. Suitable sealing is provided by the peripheral gasket ideally formed of rubber. Stops are preferably provided which control the opening and closing of the hatch cover to prevent damage to the mechanisms and driving movement of the hatch cover. All of the components of the hatch covers are formed of materials having suitable strength to resist damage or breaking during extreme weather conditions.

When loaded on a railcar, the hopper containers 10 are similarly filled with grain or other particulate materials by loading the compartments through the respective hatch covers thereof similarly to conventional hopper railcars. When it is desirable to transfer the product being shipped in the hopper containers from one mode of transport to another, the hopper containers are simply lifted from the deck of the rail cars upon which they are supported to be subsequently deposited on a truck or within the cargo hull of a ship. The rectangular nature of the frame surrounding the hopper container readily permits stacking and interlocking similarly to conventional box-type intermodal containers used in the railway industries. In some embodiments, the hopper containers may be lined with a poly or plastic if needed to provide a watertight atmosphere. When the gate members and hatch covers are closed, each compartment forms an airtight and watertight enclosure, in accordance with international standards, which is sealed with respect to adjacent compartments. The frame readily permits stacking of the containers for storage and for unloading. When unloading, alignment of the gates of the various compartments with hatches of a corresponding container upon which it is supported readily permits product to be dispensed from the gate opening of a first container to the hatch opening of a second container therebelow. The narrower opening of the gates in comparison to the hatch openings ensures minimal product escapes when emptying from one container to the next.

In further embodiments, the top sheet 32 of the container may have a convex outer surface in cross sectional profile. The sheet would then curve downwardly and laterally outwardly at opposing sides to the respective: top rails 16. Suitable drainage holes may be provided in the top rails 16 to prevent accumulation of rain water at the rails.

As compared to conventional handling of grain according to current practices, the use of the hopper containers according to the present invention would involve less handling of product, quicker destination times, lower costs to the shippers and buyers, and accordingly a higher profit margin with quicker turnaround time on railcars and trucks.

The hopper container is designed and manufactured for the carriage of general grains, special crops, peas, beans of small and large bulk movements by road, rail and marine. It is designed to maintain its structural and weather tight integrity within a temperature range of −40 degree C. to 90 degree C.

The container will be constructed to be suitable for transportation in normal operating conditions by modes of: road, on flat or chassis secured at its bottom corner fittings; rail, on flat or container car secured at its bottom corner fittings; and marine, on deck or in cell guided by vertical or diagonal lashings.

The maximum gross weight of a loaded full sized 40 foot container is estimated to be 115,000 pounds with a maximum payload of 105,000 pounds and a tare weight of 10,000 pounds. The maximum gross weight of a loaded half sized 20 foot container is estimated to be 57,500 pounds with a maximum payload of 52,500 pounds and a tare weight of 5,000 pounds.

The faces of the bottom corner/center fitting protrude from lower faces of all transverse members in the base of the container by 6 MM. Similarly, the upper faces of top corner/center fittings protrude from upper faces of the highest point of the side rails by 6 MM.

The upper and bottom faces of the middle supports on the 40′0″ container protrude from upper and bottom faces of the highest point of the side rails 6 MM. The outer side faces of corner fittings and middle supports protrude from outside faces of corner posts and center posts by 3 MM.

The hopper container is mainly constructed with aluminum frames, side sheeting, roof sheeting, ends, compartment dividers, top rails, bottom rails, corner fittings, middle supports, hatch covers, bottom gates and chutes.

The bottom side rails are angle aluminum welded in place along bottom to upright post and cross members as shown in drawings. The 4 center cross-tie members top/bottom are angle aluminum welded in place between the two side rails, four center fittings, and the center divider between the middle two compartments.

The 2 top and bottom cross members at the ends are angle aluminum welded in place between lifting corner fittings, along end sheets and end posts. The cross-tie members at the intermediate dividers between the first two compartments at each end on the top/bottom are angle aluminum welded in place to dividers, top/bottom rails and to side intermediate posts between the compartments.

The 4 corner end posts are angle aluminum welded in place to end sheets, side sheets, corner fittings, cross members, bottom side rails and top side rails. The 4 middle posts, two on each side, are angle aluminum welded in place to center divider, bottom side rails, top side rails, center fittings, cross-tie members top/bottom and side sheeting. The 8 intermediate posts, four on each side, are angle aluminum welded in place to intermediate dividers, bottom/top side rails, top/bottom cross members and side sheeting.

The top side rails will be a pressed or formed aluminum. These top rails will be welded to corner posts, side sheeting, roof, middle/intermediate posts and top cross members.

The top sections of the roof are aluminum sheeting contoured to a height difference from sides to middle of the total length and welded in place to side sheets, top rails, dividers and all top cross members.

Each compartment section will have a 2 foot opening in the center of the roof sheet. The side sheets are aluminum welded in place to the roof, top rail, side posts, corner posts and hopper chutes. Each side sheet will be pressed to have a lip on top to the proper angle to accommodate the roof sheets in an overlap weld and a bottom angle of 30 degrees to accommodate the hopper chutes. The 2 end sheets are aluminum welded in place to accommodate roof sheet, top cross member, corner posts and hopper chute. Each end sheet will be pressed to have a lip on top to the proper contour and angle to accommodate the roof sheet in an over lap weld and a bottom angle of 30 degrees to accommodate the hopper chute for a lap weld.

The 4 hopper chutes are made from material cut, pressed, welded and angled from the side and end with a drop to the middle with a round opening of 1′10″ and amounting flange for the hopper gates. The hopper chute is formed aluminium sheeting and a round mount flange welded in place.

The dividers are between each compartment of the container. The center divider is an aluminum plate welded in place to cross members top/bottom, roof sheets, side post and hopper chutes. The 2 intermediate dividers are aluminum plate welded in place to cross members top/bottom, roof sheets, side posts and hopper chutes.

The hatch covers are of new design and are on top of each compartment to make a watertight fit. The hatch covers are made of aluminum and are operated from either side of the container from a motor driven device. Each cover in the closed position will be watertight and all operating mechanism free from outside elements. Each cover in the open position will be drawn up and back in a low movement, keeping the maximum height to about 5″-6″ total. Each hatch cover and arm is all one unit that slides on a grooved track on each side. The cover for the mechanism is hinged at the back and lifts up when the hatch cover pulls back. A rubber hatch seal will be of one continuous circle 3″×1″ thick and glued to cover with high strength quality glue. The opening device will be a worm gear type, operated from the back of the housing and extended to either side of the container for easy operating. Each of the hatch cover units will be bolted with locking nuts. There will be an angle bar welded to the roof sheeting for mounting the hatch cover unit.

The bottom hopper gates are of new design and are fastened to the mounting flange on the bottom of the hopper chute. Each gate unit is made from aluminum and made to seal watertight to prevent contamination of the product being carried. The hopper gate plate slides back and forth in a grooved channel set in rubber to make a proper seal. The complete unit is seal from all weather conditions other then the bottom part of the gates in the closed position. Each gate mechanism will be operated by a worm gear type device operated from the back of the housing and extended to either side of the container for easy operating. The bottom gate unit will have a round mount flange at the top to match that of the mounting flange on the hopper chute with a round gasket bolted therebetween. Each gate unit will be fastened with bolts with locking nuts.

Locking devices are provided for each hatch cover in all four locations in the closed position. Each bottom gate will have a locking device in place to secure the gate in a closed position at all four locations. Each compartment will be vented indirectly to keep the compartments from explosion or implosion.

All aluminum components and welds to be checked for edges, cleaned, grinded and washed to remove all impurity from the surface on the inside and outside.

The container improves product handling by shorter periods, easier loading and Unloading, controlled environment (protected against contamination, insects, spoilage, storage) and transportation of materials in small or large bulk volumes. The ease of handling assists the users to move their products quicker and more controlled.

Under conventional prior art systems, steps for transporting material include: farmer yard loading; trucking to elevator; elevator handling; loading into hopper cars; transport to terminals; unload at terminals; load into bulk ships; transport to ocean port; unload to terminal; reload to ocean bulk ship; ship to bulk ports; unload to terminal; reload onto trucks; and deliver to customer.

Using dry containers at the terminal the steps are reduced to yard loading; trucking to elevator; elevator handling; loading into cars; transport to port; unload into dry container; ship to destination; deliver to port for unloading; reload from lining bags to trucks; and deliver to customer.

Using containers of the present invention the steps are reduced to: yard loading; trucking to rail; unload/load on rail; transport to port; unload/load onto ship; ship to destination; unload/load to truck; and deliver to customer.

Accordingly, advantages of the hopper containers according to the present invention include less handling of grain or other granulated products; greater control of consistency; reduced shrinkage; less chance of storage loss; shorter loading times; inland loading and unloading at both destinations; less man hours for loading and unloading; safer movement of products; electronic data interchange (EDI); less elevator and warehouse expenses; no sacks, boxes, pallets and securing charges; no additional transferring of the products; less chance of contamination, spoilage, deterioration by over handling; less chance of contamination spreading to other products or container compartments; door to door shipping; less back-haul charges with other specialty products; less shipment times; lower total costs per ton; the convenience of smaller bulk orders and less waiting time of large bulk ships; less chance of lost product on route with the ease of global tracking; movement by truck, rail and ship (intermodal); Lining bags could be designed for hopper container for the movement of liquids or oils; and machine loading and unloading.

While some embodiments of the present invention have been described in the foregoing, it is to be understood that other embodiments are possible within the scope of the invention. The invention is to be considered limited solely by the scope of the appended claims.

1. A container comprising a structural frame defining a rectangular volume suitable for stacking with conventional intermodal containers and forming at least one compartment therein, said at least one compartment comprising:
a hopper formed at a bottom end of said at least one compartment which tapers downwardly and inwardly to a chute opening;
a gate member which selectively closes the chute opening of said at least one compartment; and
a hatch opening at a top end of said at least one compartment which is selectively covered by a hatch cover.

2. The container according to claim 1 wherein said, at least one compartment is formed of rigid structural materials fixed to the structural frame.

3. The container according to claim 1 wherein side walls of said at least one compartment comprise load bearing members of the structural frame.

4. The container according to claim 1 wherein side walls of said at least one compartment are substantially planar.

5. The container according to claim 4 wherein the side walls are substantially flush with exterior sides of the structural frame.

6. The container according to claim 1 wherein the structural frame comprises upright corner posts at each corner of the frame, top and bottom rails spanning between respective top and bottom ends of the corner posts on each side of the frame, corner connectors at respective corners of the frame for coupling to adjacent intermodal containers and structural sheeted material spanning between the corner posts on each side of the frame which define side walls of said at least one compartment.

7. The container according to claim 6 wherein the structural frame further comprises upright intermediate posts equally spaced between the corner posts in which the structural sheeted material spans an exterior of the intermediate posts.

8. The container according to claim 6 wherein said at least one compartment comprises a plurality of compartments and wherein the structural frame further comprises partition members spanning across an interior of the structural frame between opposing sides of the structural frame for separating the compartments from one another.

9. The container according to claim 8 wherein the partition members are formed of structural sheeted material.

10. The container according to claim 1 wherein the gate member of said at least one compartment includes an operating linkage for opening and closing the gate member, the gate member and operating linkage being selectively mounted on the hopper for ready replacement thereof.

11. The container according to claim 1 wherein the hatch cover of said at least one compartment includes an operating linkage for opening and closing the hatch cover, the hatch cover and operating linkage being selectively mounted on the compartment for ready replacement thereof.

12. The container according to claim 1 wherein the hatch cover and the gate member of said at least one compartment each include an operating linkage for opening and closing the respective hatch cover or gate member while the container is in a stacked configuration with an adjacent container of similar configuration.

13. The container according to claim 12 wherein the operating linkages are accessible by an operator at a long side of the structural frame.

14. The container according to claim 13 wherein the operating linkages are accessible by an operator at either one of two opposing long sides of the structural frame.

15. The container according to claim 1 wherein said at least one compartment comprises a plurality of compartments each having a respective gate member and a respective hatch opening.

16. The container according to claim 1 wherein the gate member is fully contained within an area bound by the frame as the hatch cover is displaced between open and closed positions thereof.

17. The container according to claim 1 wherein the hatch cover is fully contained within an area bound by the frame as the hatch cover is displaced between open and closed positions thereof.

18. The container according to claim 1 in combination with a container carrying rail car having a deck upon which the frame of the container is supported, wherein the hopper of said at least one compartment of the container is supported above the deck of the rail car.

19. The container according to claim 1 wherein the gate member and hatch cover each include a sealing member such that said at least one compartment forms an airtight enclosure when both the gate member and the hatch cover are closed.

20. The container according to claim 19 wherein said at least one compartment comprises a plurality of compartments which are sealed with respect to one another.
